(19) United States
(12) Patent Application Publication
(10) Pub. No.: US 2010/0323794 A1
(43) Pub. Date: Dec. 23, 2010

(54) SENSOR BASED HUMAN MOTION DETECTION GAMING WITH FALSE POSITIVE DETECTION

(76) Inventor: Yui-Zhang Su, Kaohsiung (TW)

Correspondence Address: Yui-Zhang Su, 235 Chung - Ho Box 8-24, Taipei, TW

(21) Appl. No.: 12/486,760

(22) Filed: Jun. 18, 2009

(51) Int. Cl. A63F 9/24; G06F 17/00

(52) U.S. Cl. 463/36; 463/42

(57) ABSTRACT

A sensor based human motion detection gaming with false positive detection uses a single sensor or a combination of sensors to measure the physical motions of the player and then uses this motion as input in an interactive game. The interactive game resides on a mobile host such as a mobile phone. The system uses algorithms on the data gathered by the sensors to determine the current physical activity being performed by the player. Game play progression is then based on the physical activity being performed. The system also filters data to detect cheating patterns that may be used by a player to gain an unfair advantage in a game that uses such a system.

### FIELD OF THE INVENTION

The present invention relates to a game of interactive entertainment, and particular to a human physical motion game that allows players to utilize both indoor and outdoor human physical motions such as walking, running etc, and use those actions to determine progress within the game. The system is made unique by incorporating detection of cheating patterns that a player may use to gain an unfair advantage within a game that uses such a system.

### DESCRIPTION OF THE PRIOR ART

Mobile phones nowadays are complex pieces of hardware with many of these devices that allow their users to multitask on various fronts. It was not long ago that a camera was considered a luxury feature on a mobile phone. Nowadays a camera is almost a standard feature on any new mobile phone that comes on the market. The same trend seems to be going towards micro sensors that are now embedded in these phones. Most of today's high end phones come embedded with some form of motion sensor or an accelerometer, along with geodetic sensors such as a GPS chip. While we certainly cannot foresee what other complex sensors maybe built into the phones of the future, we are very confident that at the very least, a whole range of phones in the immediate future will possess the above mentioned sensors. This is because there are various possibilities of applications that can be built around these sensors, which will be in huge demand by the end consumer. Such demand for applications that uses these sensors will necessitate the incorporation of such sensors into future devices, much like the demand for a camera in a phone.

In parallel to the above opportunity of sensors in mobile devices, a new era of gaming has also emerged with the invention of the Nintendo Wii. The Nintendo Wii is a unique game console that uses a sensor based controller called the Wii Remote. This Wii Remote or Wii-Mote for short uses a three axis accelerometer and optical sensor technology that enables a motion sensing capability. The user or player uses this capability to interact and manipulate objects on the screen via motion and point and click. In terms of hardware technology, the Wii Remote contains the same type of sensor hardware that is present in most high end phones today.

Most video games that exist in the market and try to utilize human physical motion are either very expensive or still make the use of corded consoles or systems. Systems such as the Nintendo Wii have games like the Wii-Fit that provide different activities that utilize human physical motions. However all games that do so, do not involve any outdoor activity and the player still requires to be playing in front of a television. In addition the cost of buying a Wii-Fit and Nintendo Wii systems costs hundreds of dollars.

Besides, the most significant drawbacks of all game systems that use human physical motion detection to determine game play is that their technology does not cover the ability of the player to cheat the system by faking physical motions. Such systems can be exploited in various ways in which the players can trick the sensors and the algorithms to think that the player is performing some kind of valid physical activity, when in reality, that is not the case. There are plenty of evidence studies that can show how players can cheat the Wii-Fit system by shaking the Wii Remote, and the game will show as player who is running. The unreal interactivity is the most significant drawback of the games.

There are other ways in which a player can put a sensor inside a blender, and that will trick the game into thinking that the human player is actually running because of the range of deviations that may match the physical motion of a player. There are systems in the market that have been hacked and cheated using the above approach. These kinds of cheats and hacks make the game play less reliable and do not reward honest players.

Additionally, there has been no bridge to create an immersive human motion based gaming on mobile devices.

### SUMMARY OF THE PRESENT INVENTION

Accordingly, the present invention provides a sensor based human motion detection game to a mobile phone with a sensor used in a gaming console.

The present invention uses algorithms which can be executed by a device having a lower performance than the game console. Besides, the present invention can also correct the defects of an existing levering game operated by human physical motion.

The present invention will not need a specific platform. User can choose a most popular, cheap platform such as a mobile phone which can be obtained by most users with a lower cost.

The invention has been carried out in view of the above highlighted issues, and therefore is directed towards using such a game system to encourage a new form of compelling and innovative mobile game play, and maintain the outdoor physical activity of players who interact with such a system.

A sensor in the above context is any device which is capable of detecting different forms of physical motion of the player. A sensor or a range of sensors can be used to measure different forms of physical motion(s). The sensor(s) above would be part of any mobile device such as a mobile phone that contains some form of microcontroller and some form of communication interface that can communicate data gathered by the sensor(s) in a real time or online operation to a game that resides on the mobile device.

In another embodiment of the above scenario the sensor(s) could be a part of any mobile device or phone that contains some form of a microcontroller and/or a form of microprocessor, which can process the data received by the sensors according to pre-determined algorithm to extract a quantifiable value or values, which can be utilized to determine progress within a game. This module would also have some form of communication interface that can communicate the information and/or data gathered in a real time or online operation to a game on the device.

In yet another embodiment of the above scenarios the sensor(s) could be a part of any mobile device or phone that further contains a method of storage that can store data and/or information, which can then be communicated through some form of communication interface in a delayed or offline operation to a game.

Another embodiment of the above system can involve a mobile phone that does not have the capability of recording human physical motion, but can communicate to any sensor based device that does have the ability to record human physical motion.

In this scenario there must be a provision in place through which the sensor based device can communicate the data and/or information gathered by the sensor based device to the mobile phone. The provision can be a wired or wireless communication interface.

A host in the above context is any system such as a mobile phone, capable of recording raw data regarding the physical motion of the user.

The host can also be any un-tethered system that has the ability to receive quantifiable human physical motion information from the sensors. Finally the host is any system on which the game that uses the human physical motion data resides.

A game in the above context is any game that intends to receive and consume the human physical motion data, and based on a certain game logic, determines in game progress and metes out rewards and incentives.

A preferred embodiment of the present invention is any commercial mobile phone containing a 3 axis accelerometer embedded in the phones main board. The phone is equipped with a microcontroller.

The sensor calculates displacement across the X, Y and Z axis. The data is transferred to the game that resides on the mobile phone via an application programming interface or API. The API could be either developed by the manufacturer of the mobile phone, or a third party software developer, or built in-house by the developers of the game.

Another embodiment experimented in our reduction to practice uses a GPS sensor to calculate displacement and velocity of the subject. The GPS sensor is attached to a board equipped with a microcontroller and a communication interface, much similar to the system above. A communication interface that receives the data transmitted by the on board sensor is equipped.

In both of the above contexts the game that resides on the un-tethered host is any game that responds to physical activity conducted by the player. In its current form we are able to identify physical motions such as walking, running, jumping and bicycling through our algorithms that work on the data gathered by the above mentioned sensor solutions. In game progress is determined by how often and how regular the player performs physical activity within a day. Physical exercise motions of the player can be visualized in real time or recorded non real time in the game in the form relevant animations, based on the physical exercise being currently conducted.

For instance, when a player is running equipped with the sensor supported phone, the game shows some form of virtual avatar running on the display screen of the host. The moment the player stops running, so does the avatar. In another example of physical motion, when a players rides a bike, the game shows a avatar riding a bike and stopping and starting as and when the player does so in real life. In game rewards in the form of points are handed out on the successful completion of the exercise regiment for that day. These points can be used to buy various in-game upgrades and unlock mini-games and other features that enhance the player's avatar.

In an extension of the above game, the game can contain various mini-games as well which require players to perform physical activities in order to complete the mini-game.

The present invention also recognizes social interactions between players to encourage a game based community that constantly compares and challenges each other for in-game progress and rewards. The current embodiment of our reduction to practice allows players to challenge avatars of other players through various multi-player challenges.

The present invention also allows for the ability to gather game data and statistics of the game play, and communicate that data and/or information to another host. The gathered data and/or information can then be used by the players to create visualizations and statistics of their own physical activities they have performed while playing the game, and to measure those activities up against certain user-defined goals.

The present invention fills a critical gap and solves the current problems described above. The present invention is also cheap and not limited to be played in front of a TV. There are no games that utilize mobile devices and their sensor capabilities the way our system does. In addition, there exists no system that detects cheating patterns among players who can exploit such hacks and tricks and make the game less reliable. Our system, and games that use our system, provide reliable detection and reward honest game play. Our system aims to promote an engaging, cheap and cheat free method that promotes games that use human physical motions, thereby increasing the likelihood of a long term success of these games.

### BRIEF DESCRIPTION OF THE DRAWINGS

FIG. 1 is a system diagram of the present invention.

FIG. 2 is a schematic view showing an operation of a game of the present invention.

FIG. 3 is a system diagram showing another embodiment of the present invention.

FIG. 4 is a system diagram showing one another embodiment of the present invention.

FIG. 5 is a system diagram showing a yet another embodiment of the present invention.

FIG. 6 is a schematic view showing a usage of the present invention.

FIG. 7 is a schematic view showing another usage of the present invention.

FIG. 8 is a schematic view showing one another usage of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

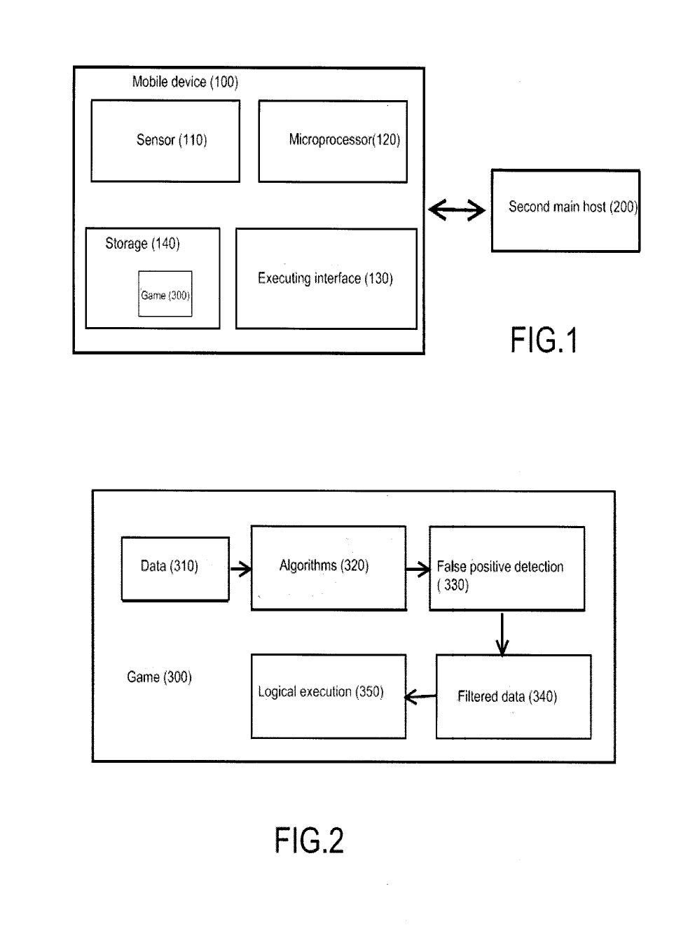

Referring to FIG. 1 and FIG. 2, a sensor based human motion detection gaming with false positive detection according to the present invention fills a vital gap between expensive systems that provide compelling game play, but are limited to indoor activities and provide no outdoor physical exercise, and systems that do not have provisions in place to detect cheating patterns by the player thereby giving the player and unfair and undeserved advantage.

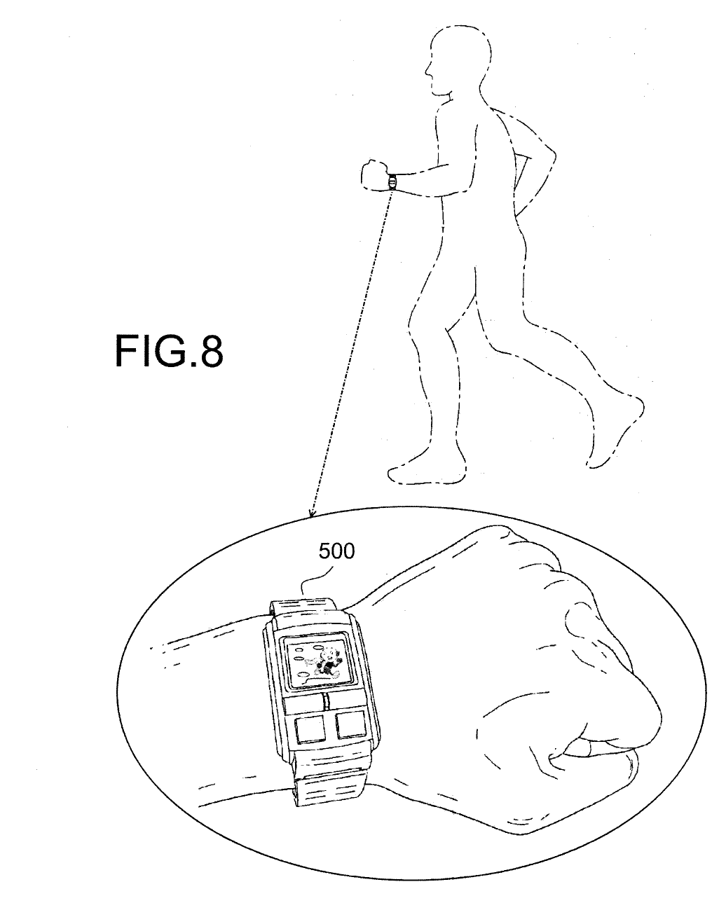

An embodiment of the present invention can be applied to a mobile device 100 (or a first host) with sensor of a 3 axis accelerometer and a GPS chip such as a latest generation mobile phone and the cell phone we are targeting right now, and a watch 500 shown in FIG. 8. The present invention includes following components.

A sensor 110 consists of a single sensing component or a plurality of sensing components capable of sensing human physical motions and gathering as data. The sensor 110 can be one of the following sensors of a thermal sensor, electromagnetic sensor, mechanics sensor, chemical sensor, optical sensor, acoustics sensor, biological sensor, and a geodetic sensor. The sensor serves to detect physical motions of a specific target, and the motions are not limited to motions such as waking, running, jumping, bicycling and so on.

A microprocessor 120 serves to process the data 310 gathered by the sensor 110 as shown in FIG. 2. The microprocessor 120 is also responsible for executing game logic and any other necessary operations.

An executing interface 130 as shown in FIG. 1 could be a wire or wireless connecting capable of two-way transferring the calculated data from the microprocessor 120 to a game 300 stored in a storage 140 which will be mentioned in the following.

The storage 140 as shown in FIG. 2 includes the game 300. The game 300 according to the present invention is defined as a gaming program or hardware with a gaming program. The game 300 includes algorithms 320 for calculating data from physical motions of a player and a false positive detection 330. The data 310 will be calculated by algorithms 320 through the microprocessor 120, a filtered data 340 is generated after extracting the gathered data containing a cheating pattern so that a proper gaming result will be presented by a logical execution 350 (also called a gaming engine which is software or hardware) of the game 300.

The false positive detection is based on unique patterns of the three axis caused by human physical motions. According to parameters like times, deviations of the maximum and minimum values of the quantification of the patterns, a false motion in a certain interval can be detected. Such false motions will not be counted in the game especially in a match or scoring game.

Accordingly, the false positive detection can be carried in three levels. The first level is in a single pre-defined time period; to check if the numbers of local minima and maxima points reach a threshold.

Some people can find a way of orientation to reach the above mentioned threshold. The level two detection uses a low-pass filter to remove any small oscillations, and then calculates the average of all the local maxima and minima.

The level three detection is a matching test which will sample data in a longer time period, and find the possible pattern in it. Then we use the pattern to match the data in this period with others similar patterns if they exist. If they exist we can detect that pattern as one of cheating and catch it as well.

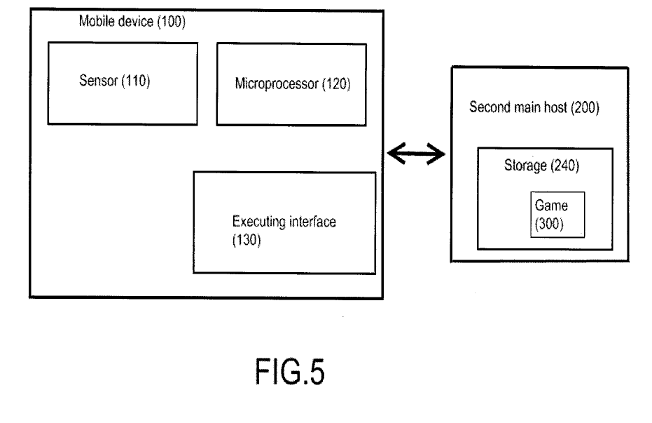

Another embodiment of the present invention is illustrated in FIGS. 7 and 4, the sensor 110 can be separated from the mobile device 100 and can be wear to human body such as an arm shown in FIG. 7. The mobile device thus becomes a first external main host. A transmitting unit B and a receiving unit A responsible for the wire/wireless communication are needed in such configuration. Referring to FIG. 7, the transmitting unit B is arranged to the sensor 110 for transmitting the gathered data to the mobile device 100 equipped with a receiving unit A. The first external main host which is the mobile device 100 and other components are not necessary combined in a whole body.

In the FIGS. 4 and 7, the gaming status can be transferred to a second main host 200. The second main host 200 can be a single host or multiple hosts. The gaming status can be displayed on a screen as shown in FIG. 7, or can be interacted with far end terminal through Internet 202 or other digital network. The game play will be affected by combination of data from a plurality of players.

Moreover, the algorithms 320 of the present invention is a program based on data of human physical motions for detecting physical motions of the player.

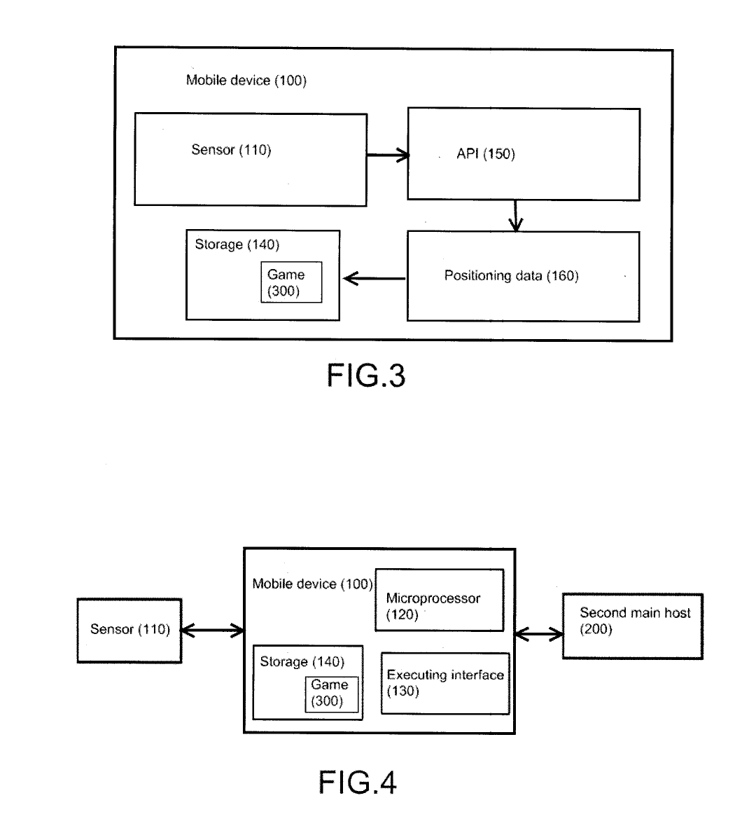

With reference to FIG. 3, another generalized embodiment according to the present invention is illustrated. A game 300 for human health is integrated into a modular sensor. The modular sensor has an application programming interface 150 for process the data sensing by a sensor 110, and a storage 140 consists of the game 300 and algorithms 320 receiving data through the application programming interface 150.

The game 300 will have better performance on data integration of sensor 110 through the application programming interface (API) 150. The API 150 can provide positioning data 160 on each X, Y, and Z axis and improve a sensing to precise motions along the X, Y, and Z axis performed by the player.

The game for human health is related to at least one of the following activities or physical motions like walking, running, jumping, or bicycling.

The false positive detection 330 is illustrated in FIGS. 1 and 2. The false positive detection 330 serves to filter data so that a cheating pattern of human physical motions unacceptable by the game is filtered from the game.

The false positive detection 330 is capable of differentiating a false motion between a real physical motion. The operation of the false positive detection 330 could be mistaken for an effective motion under a device without the algorithms 320.

The API 150 and the storage 140 of the present invention can be integrated into a modular sensor, and also a sensor 110 for gathering data of human physical motions. A mobile device 100 is arranged so that the sensor 110 is separated from the modular sensor.

The processing includes the follwing step. (a) Quantified data of human physical motions gathered by the sensor 110 are generated by calculation as set forth in claim 6. (b) The API 150 of the game can collect partial quantified data of human motion. (c) The API 150 of the game is capable of processing above data. (d) The API 150 of the game can store partial quantified data of human motion.

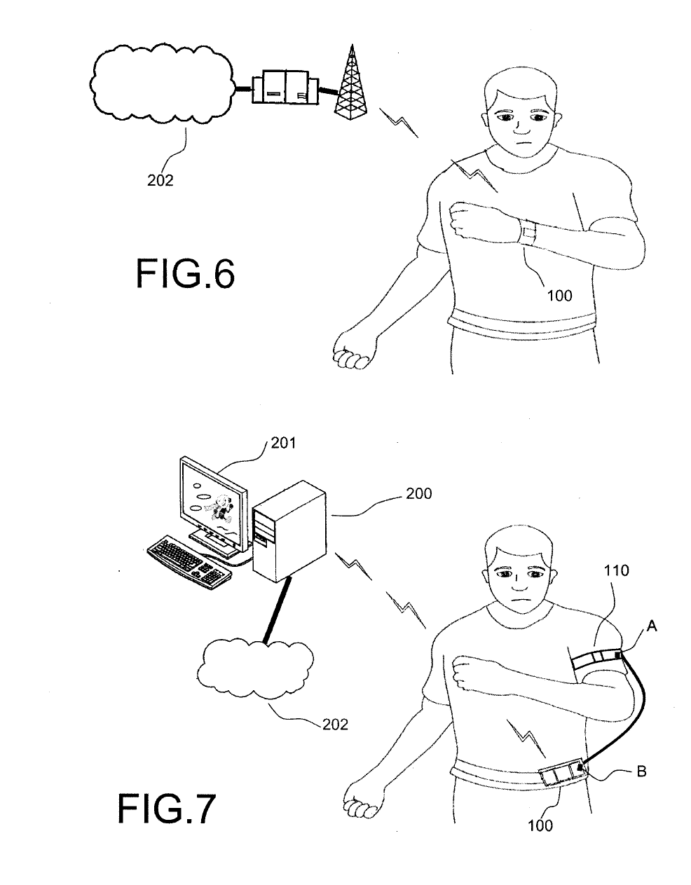

Referring to FIG. 5, a generalized embodiment of the present invention is illustrated. A sensor 110, microprocessor 120, and an executing interface 130 are arranged in a mobile device. Processed results of the microprocessor 120 are transferred to a second external main host 200 and being executed by a game 300 located in a storage 240 of the second main host 200 and then shown in a screen 201. Furthermore, the results of the microprocessor 120 can be interacted with far end terminal through Internet 202 or other digital network as shown in FIG. 6. The game play will be affected by combination of data from a plurality of players.

The modular sensor of the game for human health is capable of: (a) generating quantified data from human motion data gathered by the sensor 110 through the algorithms 320; (b) collecting partial quantified data of human motion by the interface of the game; (c) processing the above data by the interface; (d) storing the partial quantified data of human motion.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sensor based human motion detection gaming with false positive detection comprising:
a sensor for gathering data of physical motion of a player;
a microprocessor for processing the motion data gathered by the sensor;
an executing interface capable of two-way transferring the sensed data between the microprocessor and a game stored in a storage;
the storage including the game and algorithms and a false positive detection; the storage receiving the data being calculated by algorithms through the microprocessor, the algorithms extracting the data containing a cheating pattern so that a proper gaming result will be presented by a logical execution.

2. The sensor based human motion detection gaming with false positive detection as claimed in claim 1, wherein the sensor can be one of a thermal sensor, electromagnetic sensor, mechanics sensor, chemical sensor, optical sensor, acoustics sensor, biological sensor, and a geodetic sensor for sensing physical motions of a predetermined target.

3. The sensor based human motion detection gaming with false positive detection as claimed in claim 2, wherein the sensor is capable of sensing at least one of the activities of walking, running, jumping, or bicycling.

4. The sensor based human motion detection gaming with false positive detection as claimed in claim 1, wherein the executing interface, microprocessor, and the storage are arranged into a mobile device; the sensor is separating from the mobile device so that the sensor can be equipped to other location of a human body from the mobile device which is a first external main host.

5. The sensor based human motion detection gaming with false positive detection as claimed in claim 4, wherein a transmitting unit and a receiving unit for executing one of a wire or wireless communication are arranged to the sensor and the mobile device individually.

6. The sensor based human motion detection gaming with false positive detection as claimed in claim 2, wherein the processed result of the microprocessor is connected to a second main host.

7. The sensor based human motion detection gaming with false positive detection as claimed in claim 1, wherein the algorithms is a program based on data of human physical motions for detecting physical motions of the player.

8. A game for human health integrated into a modular sensor, the modular sensor comprising:
a storage including the game; the game having algorithms; the application programming interface receiving data from the algorithms.

9. A game for human health as claimed in claim 8, wherein the game is related to at least one of the following activities or physical motions like walking, running, jumping, or bicycling.

10. A game for human health as claimed in claim 8, wherein the game includes a false positive detection.

11. The sensor based human motion detection gaming with false positive detection as claimed in claim 10, wherein the false positive detection serves to filter data so that a cheating pattern of human physical motions unacceptable by the game is filtered from the game and a proper result is presented by a logical execution of the game.

12. The sensor based human motion detection gaming with false positive detection as claimed in claim 10, wherein the false positive detection is capable of differentiating a false motion between a real physical motion; the operation of the false positive detection could be mistaken for a effective motion under a device without the algorithms as set forth in claim 7.

13. A game for human health as claimed in claim 8, wherein the application programming interface and the storage is integrated into the modular sensor, and also a sensor for gathering data of human physical motions; a mobile device is arranged, and the sensor is separated from the modular sensor.

14. The sensor based human motion detection gaming with false positive detection as claimed in claim 1, wherein the game play will be affected by combination of physical motion data from a plurality of players.

15. A game for human health as claimed in claim 8, wherein the processing of the mobile device with the sensor includes the following step; (a) quantified data of human physical motions gathered by the sensor 110 are generated by calculation as set forth in claim 6; (b) the application programming interface of the game will collect partial quantified data of human motion; (c) the application programming interface of the game is capable of processing above data; (d) the application programming interface of the game will store partial quantified data of human motion.

16. A game for human health with a modular sensor having a sensor and a microprocess as claimed in claim 1 arranged into a mobile device; the processed result of the microprocessor will be connected to an external second main host.
